(19) United States
(12) Patent Application Publication
(10) Pub. No.: US 2009/0228537 A1
(43) Pub. Date: Sep. 10, 2009

(54) Object Allocation System and Method

(76) Inventors: Steven J. Branda, Rochester, MN (US); William T. Newport, Rochester, MN (US); John J. Stecher, Rochester, MN (US); Robert Wisniewski, Rochester, MN (US)

Correspondence Address: IBM-Rochester c/o Toler Law Group, 8500 Bluffstone Cove, Suite A201, Austin, TX, 78759, US

(21) Appl. No.: 12/044,493

(22) Filed: Mar. 7, 2008

(51) Int. Cl. G06F 12/00

(52) U.S. Cl. 707/206; 707/E17.005

(57) ABSTRACT

A method, apparatus and program product include an object heap having memory space dedicated to individual threads. Individual threads may allocate objects into their respective, assigned spaces. If their space should become full, the thread may allocate an object to a shared space of the object heap. Filling the space in this manner may allow the thread to continue working, without pauses. The thread may be continued to allocate objects and otherwise complete the work until it is done, and before any associated cleanup and consequent pauses. A garbage collection algorithm minimizes pauses for a given transaction by making the garbage collection scheme aware of the presence of end to end transactions. This awareness may allow the system to make appropriate decisions for optimizing object allocation processes.

### FIELD OF THE INVENTION

The invention generally relates to computers and computer software. More specifically, the invention relates to the management of data structures and functions in an object oriented programming system.

### BACKGROUND OF THE INVENTION

Managing available memory is critically important to the performance and reliability of a computer system. Such systems must store vast quantities of data within limited memory address space. Data is commonly stored in the form of objects. Memory space allocated for an object is known as an object heap. Typically each computer program has its own object heap.

Objects comprise both data structures and operations, known collectively as methods. Methods access and manipulate data structures. Objects having identical data structures and common behavior can be grouped together into classes. Each object inherits the data structure and methods of the particular class from which it was instantiated. Further, a hierarchical inheritance relationship exists between multiple classes. For example, one class may be considered a parent of another, child class. The child class is said to be derived from the parent class and thus, inherits all of the attributes and methods of the parent class.

Object structure includes data and object reference fields. Object references may contain the memory addresses or other information associated with other memory locations and objects. The object 10 of FIG. 1 has an identifier field 12; data field/item 14 and object references 16, 18. In some applications, object references are referred to as pointers. The identifier field 12 contains processing instructions used only when the object 10 is compiled, so it is not necessarily stored with the object 10. Dashes distinguish the identifier field 12 from information stored at run time.

In FIG. 1, object references 16 are represented as arrows pointing to other objects/items 20. That is, an object reference 16 may comprise a pointer, which in turn, may include an actual memory address where an object is located within the object heap. A null value of object reference 18 is represented by an “X” within the corresponding field. Items 14 are contained by the object 10 and are referred to as internal objects, while items 20 referenced by the object's 10 object references 16 are known as external objects.

The exemplary object 10 also has names 22 associated with it. Each name may comprise a labeled pointer to the object. Since names are only used by the compiler at compile time, they do not require any storage at run time. This fact is represented by the use of dashed boxes to enclose the name pointers. Note that external objects can also contain pointers to other objects recursively, creating an object with arbitrary depth.

The depth of an object is determined by counting the number of object references that must be followed to reach it, starting from a name. In FIG. 1, names 22 are at depth 0, and the object 10 is at depth 1. The external items 20 are at depth 2. For consistency, the depth attributed to the manipulation of an object reference corresponds to the depth at which the object reference is stored. Thus, manipulations of object references 16 as shown in FIG. 1 are considered to be at depth 1.

Whenever a program creates a new object, available memory is reserved using a process known as memory allocation. The Java programming environment is one example of a programming framework that utilizes memory allocation. Given the limited amount of memory available in such an environment, it is important to deallocate memory reserved for data no longer in use. Otherwise, system performance will suffer as available memory is consumed.

A computer program known as a garbage collector empties unused memory that has been allocated by other programs. Generally, a garbage collection algorithm carries out storage management by automatically reclaiming storage. Garbage collectors are typically activated when an object heap becomes full. Garbage collection algorithms commonly determine if an object is no longer reachable by an executing program. A properly collectable object is unreachable either directly or through a chain of pointers.

Thus, the garbage collector must identify pointers directly accessible to the executing program. Further, the collector must identify references contained within that object, allowing the garbage collector to transitively trace chains of pointers. When the data structure of an object is deemed unreachable, the garbage collector reclaims memory. The memory is deallocated even if it has not been explicitly designated by the program.

Specific methods for memory reclamation include reference counting, mark-scan and copying garbage collection. In reference counting collection, each external object is associated with a count reflecting the number of objects that point to it. Every time a new pointer implicates an external object, the count is incremented. Conversely, the count is decremented every time an existing reference is destroyed. When the count goes to zero, the object and its associated count are deallocated.

A variation of the reference counting scheme, known as weighted reference counting, removes the requirement of referencing shared memory, but some bookkeeping is still required at run time. Another variation, known as lazy reference counting, reduces the run-time CPU requirements by deferring deallocation operations and then combining them with allocations, but does not eliminate them entirely.

An alternative method, mark-scan garbage collection, never explicitly deallocates external objects. Periodically, the garbage collection process marks all data blocks that can be accessed by any object. Unreachable memory is reclaimed by scanning the entire memory and deallocating unmarked elements.

Each cycle of the mark-scan algorithm sequentially operates in mark and sweep stages. In the mark stage, the collector scans through an object heap beginning at its roots, and attempts to mark objects that are still reachable from a root. An object is deemed reachable if it is referenced directly by a root or by a chain of objects reachable from a root. In the sweep stage, the collector scans through the objects and deallocates any memory reserved for objects that are unmarked as of completion of the mark stage. Some variations of mark-scan require that active program threads be halted during collection, while others operate concurrently.

Copying garbage collectors are similar to those of the mark-scan variety. However, instead of marking those items that can be reached by reference, all reachable data structures are periodically copied from one memory space into another. The first memory space can then be reclaimed in its entirety. A specific implementation of a copying garbage collector is a generational garbage collector, which partitions an object heap into new and old partitions. A generational garbage collector relies on a tendency for newer objects to cease to be used more frequently than older objects. Put another way, as an object is used over time, it becomes less and less likely that the object will cease being used.

One of the most efficient types of garbage collectors is a generational garbage collector. In a generational garbage collector, new objects are allocated in a young generation area of the heap. If an object continues to have references over a specified number of garbage collections cycles, the object is promoted to one or more old generation areas of the heap. A generational garbage collector performs garbage collection frequently on the young generation area of the heap, while performing garbage collection less frequently on old, or tenured, generation areas. This technique strives to match typical program behavior in that most newly created objects are short-lived, and are thus reclaimed during garbage collection of the young generation. Long-lived objects in the old generation areas tend to persist in memory. Hence, the old generation areas need to be garbage collected less frequently. This greatly reduces the effort involved in garbage collection because only the young generation area of the heap needs to be garbage collected frequently.

Despite the progresses afforded by the above garbage collection techniques, obstacles to memory management remain. One particular area of concern relates to processing delays attributable to garbage collectors. System performance must typically be interrupted, or paused, while a garbage collector executes. Associated delays of a second or more can severely degrade system performance. Such scenarios become exacerbated where extremely large caches are involved. For instance, a Java Virtual Machine, or JVM, routinely includes larger caches (larger than four gigabytes) that must be frequently updated and modified. Garbage collection processes must become more specialized in order to fulfill the needs of server workloads. One such need may be quality of service, which includes predictable and quick response time. A way to fulfill this need would be to guarantee users zero to near zero pauses experienced during their transactions. Current Garbage Collection algorithms cannot promise this.

More particularly, conventional JVM garbage collection models incur massive and unacceptable response time drop-offs as objects are updated in the cache sitting in the old space. It may take an unacceptable amount of time to promote the object from the new space to the old space. Long delays may additionally be suffered as the corresponding old object is garbage collected from the tenured heap, which may be larger than four gigabytes.

For at least the above reasons, there exists a need for an improved manner of managing stored objects.

### SUMMARY OF THE INVENTION

The present invention provides an improved computer implemented method, apparatus and program product for managing an object memory heap, the method comprising dedicating a portion of the object memory heap to a thread, and using the thread to allocate an object to the dedicated portion of the object memory heap.

In one embodiment that is consistent with the underlying principles of the present invention, another portion of the object memory heap may be dedicated to another thread. Accordingly, that other thread may allocate another object to the other dedicated portion of the object memory heap.

Aspects of the invention include using the thread to perform a garbage collection on the dedicated portion of the object memory heap. The garbage collection may be performed after a task of the thread has been completed.

In another aspect of the invention, another object may be allocated by the thread to a shared space of the object memory heap. This allocation may occur when the dedicated portion of the object memory heap is full.

Embodiments consistent with the invention may initially identify the thread for assignment to the dedicated portion of the object memory heap. The dedicated portion of the object memory heap may be dedicated to the thread based upon work performed by the thread. In another instance, another object may be allocated to a shared space portion of the object memory heap by another thread based upon work performed by the other thread.

According to another aspect of the invention, embodiments may divide the object memory heap or otherwise create dedicated portions. The working capacity of the dedicated portion and/or the shared space portion of the object memory heap may be automatically determined and monitored. The size of the dedicated portion of the object memory heap may be configurable, dynamically, where appropriate.

These and other advantages and features that characterize the invention are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments of the invention.

### BRIEF DESCRIPTION OF THE DRAWINGS

FIG. 1 represents an object executable by embodiments of the present invention.

FIG. 2 is a networked computer system configured to allocate objects in a manner that is consistent with embodiments of the invention.

FIG. 3 is a block diagram of an exemplary hardware and software environment for a computer from the networked computer system of FIG. 2.

FIG. 4 shows an object heap having heap space dedicated to individual threads.

FIG. 5 is a flowchart having steps executable by the system of FIG. 3 for managing object allocation.

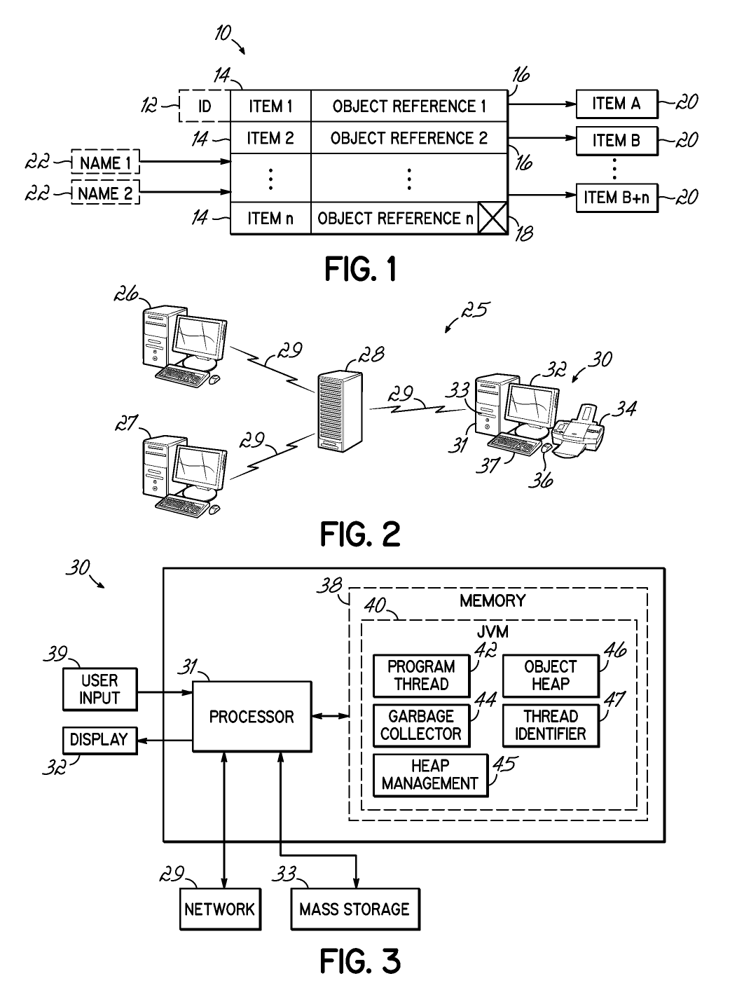

### DETAILED DESCRIPTION

Embodiments consistent with the present invention may include an object heap having memory space dedicated to individual threads. Individual threads may allocate objects into their respective, assigned spaces. If their space should become full, the thread may allocate an object to a shared space of the object heap. Filling the space in this manner may allow the thread to continue working, without pauses. The thread may continue to allocate objects and otherwise complete the work until it is done, and before any associated cleanup and consequent pauses. In one aspect of the invention, a garbage collection algorithm minimizes pauses for a given transaction by making the garbage collection scheme aware of the presence of end to end transactions. This awareness may allow the system to make appropriate decisions for optimizing object allocation.

A thread may include a structure at the virtual machine layer that can be scheduled to do work. As such, a thread may include an entity that is assigned a piece of work to do until the results are committed and the work is done. When a thread is scheduled, or assigned, to accomplish work, the thread may execute all the code that is involved in the work. The thread is schedulable for CPU time.

An example of a transaction performed by a thread may include a webpage request. If a user wants information regarding their stock portfolio, a single transaction may include gathering information regarding the stocks associated with the user through two points in time. As such, the thread may go through a database and write the applicable information and webpage to a user.

Embodiments consistent with the underlying invention divide the object heap space into multiple sections. One section may be considered the shared space and may be tunable via a configuration parameter. This shared space is typically divided evenly. The rest of the heap space may be divided evenly amongst each designated thread in the application. Threads may be designated according to any number of schemes. For instance, threads of interest may be designated according to a transaction or other work performed by the thread. In one example, if a transactional thread pool is sized at 50, then there may be 50 individual heap spaces, one for each thread.

When a thread allocates an object, that object may be allocated in the thread's local heap space. If that heap space fills, the thread may allocate objects into the active half of the shared heap space. When an object is allocated as such, a local garbage collection may be executed by the thread on the thread's local space. This collection may occur only after the current transaction is completed. In one embodiment, only the thread, itself, is used to garbage collect it's local space. This arrangement offers certain efficiencies, as the thread is likely to have no work to do, anyway. Thus, the thread may accomplish its own collection instead of going to sleep while another thread is drawn away from other work to do the collection.

Similar to generational garbage collection, the number of marks of a given object may be recorded. If the local thread notices that an object has been persisting for multiple garbage collections, the thread may graduate that object to the shared space. This process may maximize the available space for transaction scoped objects, and allow the thread to work within it's own space more.

The shared space may be handled in halves. At any one time, only one half may be active for new object allocation (as overflow from transactional threads). When space is needed, the active heap may be reversed. An asynchronous garbage collection may be initiated on the now deactivated half. This process may allow for constant availability of an active space. This constant availability may help avoid pauses in the transactional threads.

In this manner, embodiments may greatly minimize the likelihood of pauses. Moreover, aspects of the invention may create opportunities to warn administrators about likely pause situations by monitoring the frequency and duration of the garbage collections happening on each individual heap space.

### Hardware Environment

Turning to the Drawings, wherein like numbers denote like parts throughout the several views, FIG. 2 illustrates a computer system 25 configured to allocate objects in a manner that is consistent with embodiments of the invention. The computer system 25 is illustrated as a networked computer system including one or more client computer systems 26, 27 and 30 (e.g., desktop or personal computers, workstations, etc.) coupled to a server 28 through a network 29.

The network 29 may represent practically any type of networked interconnection, including, but not limited to, local area, wide area, wireless, and public networks, including the Internet. Moreover, any number of computers and other devices may be networked through the network 29, e.g., multiple servers. Furthermore, it should be appreciated that aspects of the invention may be realized by stand-alone computers and associated devices.

Computer system 30, which may be similar to computer systems 26 and 27, may include one or more processors, such as a processor 31. The system may also include a number of peripheral components, such as a computer display 32 (e.g., a CRT, an LCD display or other display device), and mass storage devices 33, such as hard, floppy, and/or CD-ROM disk drives. As shown in FIG. 2, the computer system 30 also includes a printer 34 and various user input devices, such as a mouse 36 and keyboard 37, among others. Computer system 30 operates under the control of an operating system, and executes various computer software applications, programs, objects, modules, etc. Moreover, various applications, programs, objects, modules, etc. may also execute on one or more processors in server 28 or other computer systems 26, 27, such as a distributed computing environment.

It should be appreciated that the various software components may also be resident on, and may execute on, other computers coupled to the computer system 25. Specifically, one particularly useful implementation of an execution module consistent with the invention is executed in a server such as a System i minicomputer system available from International Business Machines Corporation. It should be appreciated that other software environments may be utilized in the alternative.

In general, the routines executed to implement the illustrated embodiments of the invention, whether implemented as part of an operating system or a specific application, program, object, module or sequence of instructions, may be referred to herein as computer programs, algorithms, or program code. The computer programs typically comprise instructions that, when read and executed by one or more processors in the devices or systems in computer system 30, cause those devices or systems to perform the steps necessary to execute steps or elements embodying the various aspects of the invention.

Moreover, while the invention has and hereinafter will be described in the context of fully functioning computer systems, those skilled in the art will appreciate that the various embodiments of the invention are capable of being distributed as a program product in a variety of forms. The invention applies equally regardless of the particular type of computer readable signal bearing media used to actually carry out the distribution. Examples of signal bearing media comprise, but are not limited, to recordable type media and transmission type media. Examples of recordable type media include volatile and non-volatile memory devices, floppy and other removable disks, hard disk drives, magnetic tape, and optical disks (CD-ROMs, DVDs, etc.). Examples of transmission type media include digital and analog communication links.

### Software Environment

FIG. 3 illustrates a suitable software environment for computer system 30 consistent with the invention. A processor 31 is shown coupled to a memory 38, as well as to several inputs and outputs. For example, user input 39 may be received by processor 31, e.g., by a mouse 36 and a keyboard 37, among other input devices. Additional information may be passed between the computer system 30 and other computer systems in the networked computer system 25 via the network 29. Additional information may be stored to and/or received from mass storage 33. The processor 31 also may output data to the computer display 32. It should be appreciated that the computer system 30 includes suitable interfaces between the processor 31 and each of the components 29, 32, 33, 36, 37 and 38, as is well known in the art.

A JVM 40 may reside in the memory 38, and is configured to execute program code on processor 31. In general, a virtual machine is an abstract computing machine. Instructions to a physical machine ordinarily conform to the native language of the hardware, itself. In other cases, the instructions control a software-based computer program referred to as the virtual machine, which in turn, controls the physical machine. Instructions to a virtual machine ordinarily conform to the virtual machine language. For instance, bytecodes represent a form of the program recognized by the JVM 40, i.e., virtual machine language. As known by one of skill in the art, the JVM 40 is only one of many virtual machines. Most any interpreted language used in accordance with the underlying principles of the present invention may be said to employ a virtual machine. The MATLAB program, for example, behaves like an interpretive program by conveying the user's instructions to software written in a high-level language, rather than to the hardware.

As shown in FIG. 3, the JVM 40 may execute one or more program threads 42, as well as a garbage collector algorithm 44 that is used to deallocate unused data stored in an object heap 46. The JVM 40 may also include a heap management program 45 used for allocation and a thread identifier program 47 for designating threads. More particularly, the heap management program 45 may manage memory allocation functions and coordinate garbage collection processes. The thread identifier program 47 may function to facilitate the automated or manual identification of threads of interest. Threads of interest may include threads assigned to a particular transaction or other work process.

The JVM 40 may be resident as a component of the operating system of computer system 30, or in the alternative, may be implemented as a separate application that executes on top of an operating system. Furthermore, any of the JVM 40, program thread 42, garbage collector algorithm 44, heap management program 45, object heap 46, and thread identifier program 47 may, at different times, be resident in whole or in part in any of the memory 38, mass storage 33, network 29, or within registers and/or caches in processor 31.

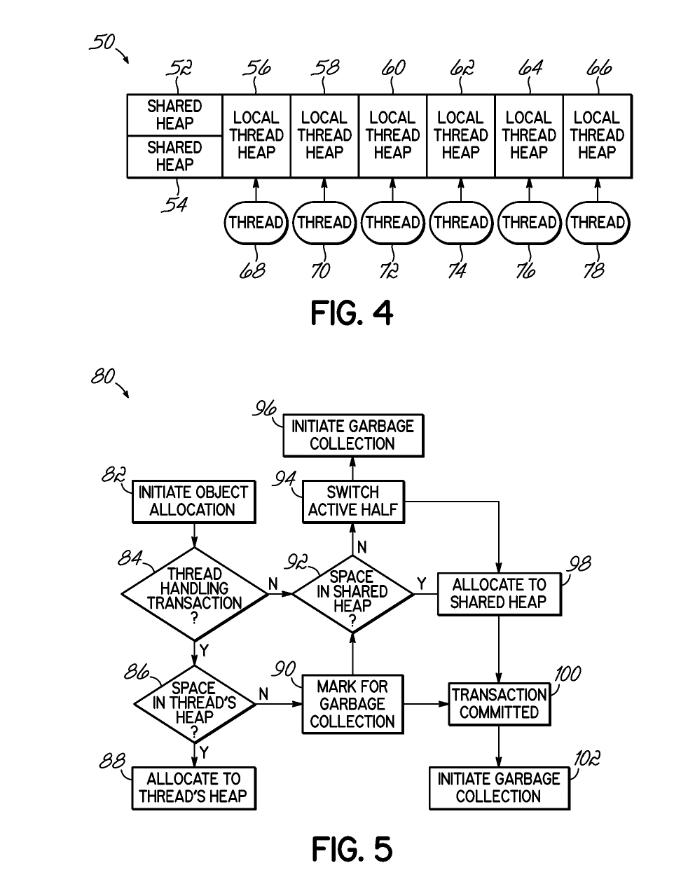

FIG. 4 shows an object heap 50 having heap space 56, 58, 60, 62, 64, 66 dedicated to individual threads 68, 70, 72, 74, 76, 78. The object heap 50 also includes shared heap space 52, 54. In one sense, the object heap 50 of FIG. 4 may correspond to the object heap 46 showed in the computer system 30 of FIG. 3.

As shown in FIG. 4, individual threads 68, 70, 72, 74, 76, 78 may respectively allocate objects and otherwise access local thread heaps 56, 58, 60, 62, 64, 66. As desired, threads 68, 70, 72, 74, 76, 78 may additionally and/or alternatively allocate objects to shared heap space 52, 54. Such a scenario may occur when a thread's 68 local thread heap space 56 is full.

Assigned, thread-associated memory space of the heap 50 may be divided evenly as between each local thread heap space 56, 58, 60, 62, 64, 66, or may be disproportionately allotted to meet an anticipated need. Moreover, shared heap space 52, 54 may be split evenly or in some other proportion, and may be substantially larger or smaller than the space designated for each local thread heap 56, 58, 60, 62, 64, 66.

As such, each thread 68, 70, 72, 74, 76, 78 may be designated, assigned or otherwise associated with a particular portion 56, 58, 60, 62, 64, 66 of the object heap 46. The size of the portions 56, 58, 60, 62, 64, 66 may be automatically or manually configurable. Where desired, program code may dynamically adjust the size of the respective heap proportions 56, 58, 60, 62, 64, 66.

Once the active shared heap portion 52 of the heap is filled up, the shared space may be flipped so that the other side 54 is active. This may result in a very slight pause, only long enough to flip the active heap space to the other side. An asynchronous garbage collection process may be collecting in the background.

Each transactional thread 68, 70, 72, 74, 76, 78 may continue to allocate objects into its dedicated local heap 56, 58, 60, 62, 64, 66 without intervention. In this manner, embodiments may avoid related pauses associated with determining where to store or make space for the object to be allocated. Should the local object heap 58 fill up, then the object may be allocated without delay to a shared heap portion 52 of the object heap.

By initiating a collection on its own local heap 58 after the completion of the work, the work is uninterrupted and pauses are avoided. Also, the thread 70 is typically available for use after completing its task, so its availability for the garbage collection process is advantageous.

While aspects of the present invention may lend themselves particularly well to use in connection with a JVM 40, it should be understood that features of the present invention may have application in other object oriented computing systems. Those skilled in the art will recognize that the exemplary environments illustrated in FIGS. 2, 3 and 4 are not intended to limit the present invention. Indeed, those skilled in the art will recognize that other alternative hardware environments may be used without departing from the scope of the invention.

While aspects of the present invention are particularly suited to identify transactional threads, other thread types may be designated by embodiments consistent with the underlying principles of the present invention. For instance, a designated thread may include a thread identified manually or automatically for any number of considerations. For instance, a designated thread may include a thread assigned work, or a particular kind of work task. In another embodiment, all threads may be designated, or threads may be designated arbitrarily.

### Object Heap Allocation Processes

FIG. 5 shows process steps executable by the computer system 30 of FIG. 3 for accomplishing object allocation and garbage collection processes in accordance with the underlying principles of the present invention. Turning more particularly to the flowchart 80, a thread 70 may desire at block 82 to allocate an object 10 into the object heap 50. The computer system 30 may determine at block 84 if the thread is handling a transaction or is otherwise designated of interest. As discussed herein, the JVM 40 or other system component may be made aware of the tasks assigned to each program thread 42. The thread identifier program code 47 may designate or otherwise identify at block 84 those threads 68, 70, 72, 74, 76, 78 which are appropriate candidates for dedicated heap space.

Should the thread 70 be identified as handling a transaction at block 84, the computer system 30 may determine at block 86 if there is adequate space in the local thread heap 58 of the thread 70. If so, the thread 70 may allocate at block 88 the object 10 to the local thread heap 58 that is designated for the thread 70.

Alternatively, where there is an adequate space in the thread's heap 58, the thread 70 may mark the local thread heap 58 for garbage collection. Where so configured, the garbage collection may not initiate until the thread's work has been accomplished at block 100.

The thread 70 may attempt to allocate at block 92 the object in active shared heap space 52. If the system determines at block 92 that there is memory space available in the shared heap 52, then the object 10 may be allocated at block 98 to the shared heap 52.

Where the computer system 30 alternatively determines at block 92 that there is no space available in the shared heap 52, then the computer system 30 may switch the active half of the object heap 50 to the other shared heap portion 54. As such, the thread may allocate at block 98 the object to the now active shared heap 54. A garbage collection may be initiated at block 96 on the now inactive shared heap portion 52. As discussed herein, an advantageous garbage collection process may include asynchronous processes, however, any type of garbage collection process may suffice.

Where the thread 70 initiating an object allocation is alternatively not handling a transaction or designated form of work at block 84, then the computer system 30 may allocate at block 92 the object into the shared heap 52.

Once the thread 70 has accomplished its transaction or other work at block 100, the computer system 30 may initiate a garbage collection. As discussed herein, the garbage collection may be accomplished by the thread 70 on the thread's own local thread heap 58.

In operation, embodiments consistent with the underlying principles of the present invention may include a garbage collection algorithm that minimizes pauses for a given transaction, or work process. Aspects consistent with the invention enable the garbage collection algorithm to be aware of the presence of end to end transactions. Program code may make decisions as to garbage collection and memory allocation, accordingly.

Embodiments consistent with the invention may divide the heap space into multiple sections. One section may be considered a shared space. The shared space may be tunable using a configuration parameter. The shared space may be divided evenly or in another proportion for purposes described herein. The remainder of the heap space may be divided evenly amongst each transactional, or working thread, in the application. If a transactional thread pool is sized at 100, then there may be 100 individual heap spaces. That is, one local heap space for each thread. A transactional, or working thread, for purposes of the specification, may include a thread performing work or that is otherwise designated programmatically or by a user.

When a thread allocates an object, the thread will typically allocate into its own, local heap space. If that heap space becomes full, the thread may allocate the object into an active half of the shared heap space. When an object is allocated into the active half of the shared heap space, a local garbage collection algorithm may be executed by the thread on its local space. This garbage collection may occur after the current work, or transaction, is completed. Preferably, only the thread, itself, is used to garbage collect its own local space. Similar to generational garbage collection, the number of marks of a given object may be recorded. If the local thread notices that an object has been persisting for multiple garbage collections, the thread may graduate that object to the shared space. This feature may maximize the available space for transaction scoped objects and allow the thread to more efficiently work within its own space.

The shared heap space is typically managed in halves. At any one time, only one of the halves is typically active for new object allocation. The active half of the shared heap space may handle overflow from the dedicated local space assigned to transactional threads. When additional space is needed in the active shared heap, the active portion of the heap is reversed. In one example, an asynchronous garbage collection process may be initiated on the recently deactivated half. This process may allow for constantly available active space. This availability may translate into the avoidance of pauses in the transactional threads.

Embodiments consistent with the present invention may minimize the likelihood of pauses and create opportunities to warn administrators about likely pause situations. Administrators may be forewarned by virtue of the program code automatically monitoring the frequency and duration of garbage collection occurrences on each individual heap space.

While the present invention has been illustrated by a description of various embodiments and while these embodiments have been described in considerable detail, it is not the intention of the Applicants to restrict, or, in any way limit the scope of the appended claims to such detail. For instance, because the Java object-oriented computing environment is well understood and documented, many aspects of the invention have been described in terms of Java and Java-based concepts. However, the Java and Java-based concepts are used principally for ease of explanation. The invention is not limited to interactions with a Java object-oriented computing environment. The invention, in its broader aspects, is therefore not limited to the specific details, representative apparatus and method, and illustrative example shown and described. Accordingly, departures may be made from such details without departing from the spirit or scope of Applicants' general inventive concept.

What is claimed is:

1. A method of managing an object memory heap, the method comprising:
dedicating a portion of the object memory heap to a thread; and
using the thread to allocate an object to the dedicated portion of the object memory heap.

2. The method of claim 1 further comprising dedicating another portion of the object memory heap to another thread.

3. The method of claim 2 further comprising allocating another object using the other thread to the other dedicated portion of the object memory heap.

4. The method of claim 1 further comprising using the thread to perform a garbage collection on the dedicated portion of the object memory heap.

5. The method of claim 4, wherein using the thread to perform garbage collection further comprises garbage collecting after a task of the thread has been completed.

6. The method of claim 1 further comprising allocating another object using the thread to a shared space of the object memory heap when the dedicated portion of the object memory heap is full.

7. The method of claim 1, wherein dedicating the dedicated portion of the object memory heap to the thread further comprises identifying the thread for assignment to the dedicated portion of the object memory heap.

8. The method of claim 1, wherein dedicating the dedicated portion of the object memory heap to the thread further comprises assigning the dedicated portion to the thread based upon work performed by the thread.

9. The method of claim 1 further comprising automatically allocating another object to a shared space portion of the object memory heap by another thread based upon work performed by the other thread.

10. The method of claim 1 further comprising automatically determining a capacity of the dedicated portion of the object memory heap.

11. The method of claim 1 further comprising determining a size of the dedicated portion of the object memory heap.

12. The method of claim 1 further comprising automatically determining a capacity of a shared space portion of the object memory heap.

13. The method of claim 1 further comprising creating the dedicated portion of the object memory heap.

14. An apparatus, comprising:
a memory comprising an object memory heap configured to store a plurality of objects;
program code resident in the memory; and
a processor in communication with the memory and configured to execute the program code to dedicate a portion of the object memory heap to a thread, and to use the thread to allocate an object to the dedicated portion of the object memory heap.

15. The apparatus of claim 14, wherein the processor is further configured to dedicate another portion of the object memory heap to another thread.

16. The apparatus of claim 14, wherein the processor is further configured to use the thread to perform a garbage collection on the dedicated portion of the object memory heap.

17. The apparatus of claim 14, wherein the thread performs the garbage collecting after a task of the thread has been completed.

18. The apparatus of claim 14, wherein the processor is further configured to identify the thread for assignment to the dedicated portion of the object memory heap.

19. The apparatus of claim 14, wherein the processor is further configured to divide the object memory heap into a plurality of dedicated portions.

20. A program product, comprising:
program code configured to assign to a thread a dedicated portion of a plurality of dedicated portions comprising a memory object heap, and to use the thread to allocate an object to the dedicated portion of the object memory heap; and
a computer readable medium bearing the program code.
